(19) United States
(12) Patent Application Publication
(10) Pub. No.: US 2019/0177084 A1
(43) Pub. Date: Jun. 13, 2019

(54) Mesh Lid Assembly

(71) Applicant: Andrew Lama, Eden (CA)

(72) Inventor: Andrew Lama, Eden (CA)

(21) Appl. No.: 15/839,354

(22) Filed: Dec. 12, 2017

(51) Int. Cl. B65F 1/16

(52) U.S. Cl. CPC B65F 1/1615

(57) ABSTRACT

A mesh lid assembly for retaining garbage in a garbage container includes a screen that may be selectively positioned over a top end of a garbage container. The screen is comprised of a deformable material to conform to a shape of the garbage container. A fastener is coupled to the screen and the fastener is selectively manipulated. The fastener selectively collapses the screen around the garbage container to retain the screen on the garbage container.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to lid devices and more particularly pertains to a new lid device for retaining garbage in a garbage container.

### BRIEF SUMMARY OF THE INVENTION

An embodiment of the disclosure meets the needs presented above by generally comprising a screen that may be selectively positioned over a top end of a garbage container. The screen is comprised of a deformable material to conform to a shape of the garbage container. A fastener is coupled to the screen and the fastener is selectively manipulated. The fastener selectively collapses the screen around the garbage container to retain the screen on the garbage container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a mesh lid assembly according to an embodiment of the disclosure.

FIG. 2 is a top view of an embodiment of the disclosure.

FIG. 3 is a bottom phantom view of an embodiment of the disclosure.

FIG. 4 is a perspective in-use view of an embodiment of the disclosure.

FIG. 5 is a cross sectional view taken along line 5-5 of FIG. 3 of an embodiment of the disclosure.

### DETAILED DESCRIPTION OF THE INVENTION

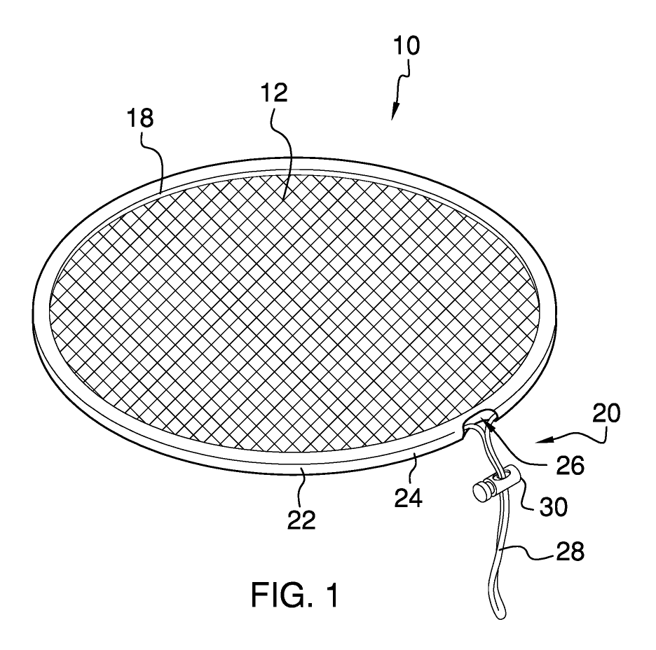

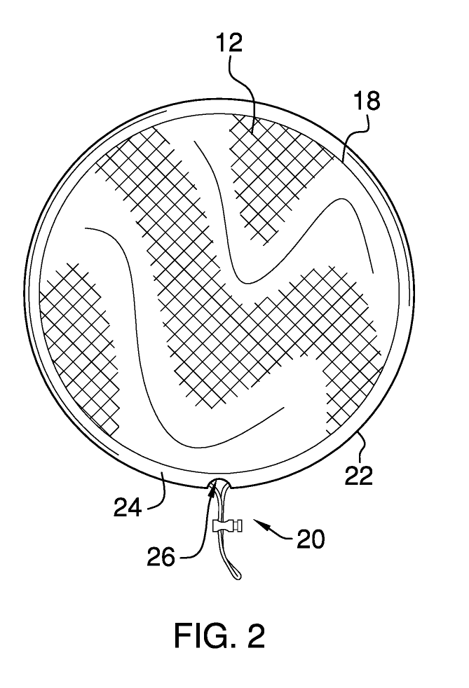

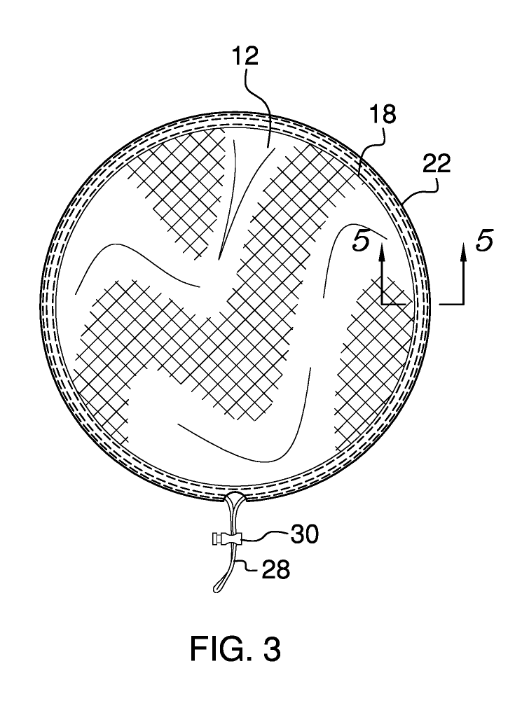

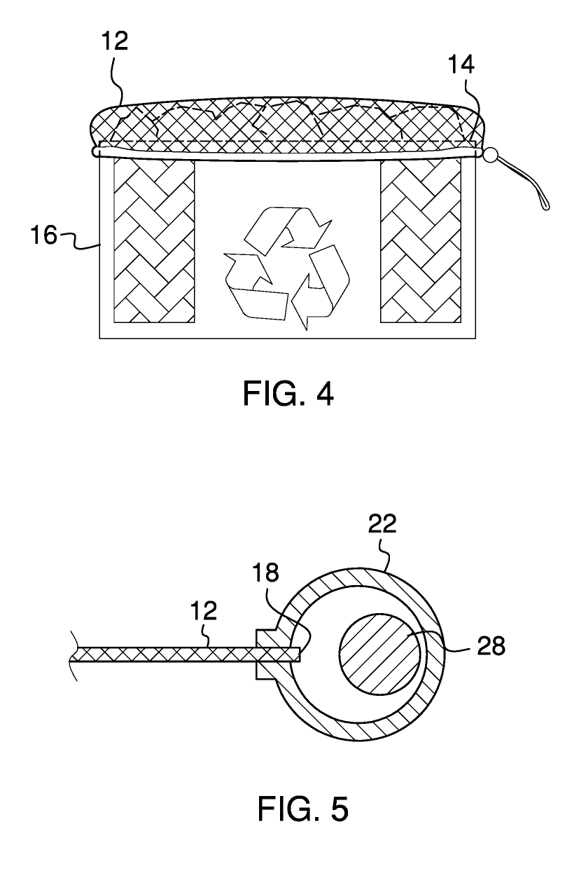

With reference now to the drawings, and in particular to FIGS. 1 through 5 thereof, a new lid device embodying the principles and concepts of an embodiment of the disclosure and generally designated by the reference numeral 10 will be described.

As best illustrated in FIGS. 1 through 5, the mesh lid assembly 10 generally comprises a screen 12 that may be selectively positioned over a top end 14 of a garbage container 16. The garbage container 16 may be a recycling can, a garbage can and any other type of garbage container 16. The screen 12 is comprised of a deformable material such as mesh or the like. Thus, the screen 12 may conform to a shape of the garbage container 16. The screen 12 has a peripheral edge 18 and the peripheral edge 18 is continuous such that the screen 12 has a disk shape. Moreover, the screen 12 may have a diameter ranging between approximately 1.0 m and 1.5 m thereby accommodating a variety of garbage container 16 sizes.

A fastener 20 is coupled to the screen 12 and the fastener 20 selectively collapses the screen 12 around the garbage container 16 to retain the screen 12 on the garbage container 16. The fastener 20 comprises a tube 22 that is coupled to the peripheral edge 18 of the screen 12. The tube 22 is coextensive with the peripheral edge 18. The tube 22 has an outer wall 24 and the outer wall 24 has an aperture 26 extending into an interior of the tube 22.

A rope 28 is provided and the rope 28 is slidably positioned in the tube 22. The rope 28 may be continuous such that the rope 28 forms a closed loop. The rope 28 extends outwardly through the aperture 26 thereby faciltiating the rope 28 to be selectively manipulated. The rope 28 decreases a diameter of the tube 22 when the rope 28 is urged outwardly from the tube 22. In this way the peripheral edge 18 of the screen 12 is selectively tightened around the garbage container 16. Additionally, the rope 28 may be comprised of a resiliently stretchable material such as bungee cord or the like for tightening around the garbage container 16.

A clasp 30 is provided and has the rope 28 slidably extends through the clasp 30. The clasp 30 frictionally engages the rope 28 at a selected point along the rope 28. Moreover, the clasp 30 is positioned outside of the tube 22 such that the clasp 30 retains the tube 22 at a selected diameter when the rope 28 is tightened. The clasp 30 frictionally disengages the rope 28 when the clasp 30 is manipulated to loosen the rope 28. The clasp 30 may be a mechanical rope 28 clasp 30 or the like.

In use, the screen 12 is positioned over the top end 14 of the garbage container 16 to cover garbage in the garbage container 16. The peripheral edge 18 of the screen 12 is manipulated to extend fully around the garbage container 16. The rope 28 is tightened to tighten the tube 22 around the garbage container 16 and the clasp 30 is slid against the tube 22. In this way the screen 12 is retained on the garbage container 16 to inhibit the garbage in the garbage container 16 from exiting the garbage container 16. The clasp 30 is manipulated to loosen the rope 28 and the screen 12 is removed from the garbage container 16 to empty the garbage container 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A mesh lid assembly being configured to be positioned on a garbage container thereby inhibiting garbage from escaping the garbage container, said assembly comprising:
a screen being configured to be selectively positioned over a top end of a garbage container, said screen being comprised of a deformable material wherein said screen is configured to conform to a shape of the garbage container; and
a fastener being coupled to said screen wherein said fastener is configured to be manipulated, said fastener selectively collapsing said screen around the garbage container wherein said fastener is configured to retain said screen on the garbage container, said fastener comprising
a tube being coupled to said peripheral edge of said screen, said tube being coextensive with said peripheral edge, said tube having an outer wall, said outer wall having a single aperture extending through said perimeter wall into an interior of said tube, and
a rope being slidably positioned in said tube extending around said peripheral edge, said rope having a section extending outwardly through said single aperture wherein said rope is configured to be manipulated, said rope decreasing a diameter of said tube when said section of said rope is pulled outwardly away from said single opening such that said rope is urged outwardly through said tube.

2. The assembly according to claim 1, wherein said peripheral edge is continuous such that said screen has a disk shape.

3. (canceled)

4. (canceled)

5. The assembly according to claim 1, further comprising a clasp having said rope slidably extending therethrough wherein said clasp is configured to be manipulated, said clasp frictionally engaging said rope at a selected point along said rope, said clasp being positioned outside of said tube such that said clasp retains said tube at a selected diameter when said rope is tightened, said clasp frictionally disengaging said rope when said clasp is manipulated.

6. A mesh lid assembly being configured to be positioned on a garbage container thereby inhibiting garbage from escaping the garbage container, said assembly comprising:
a screen being configured to be selectively positioned over a top end of a garbage container, said screen being comprised of a deformable material wherein said screen is configured to conform to a shape of the garbage container, said screen having a peripheral edge, said peripheral edge being continuous such that said screen has a disk shape; and
a fastener being coupled to said screen wherein said fastener is configured to be manipulated, said fastener selectively collapsing said screen around the garbage container wherein said fastener is configured to retain said screen on the garbage container, said fastener comprising:
a tube being coupled to said peripheral edge of said screen, said tube being coextensive with said peripheral edge, said tube having an outer wall said outer wall having a single aperture extending through said perimeter wall into an interior of said tube,
a rope being slidably positioned in said tube extending around said peripheral edge, said rope having a section extending outwardly through said single aperture wherein said rope is configured to be manipulated, said rope decreasing a diameter of said tube when said section of said rope is pulled outwardly away from said single opening such that said rope is urged outwardly through said tube, and
a clasp having said rope slidably extending therethrough wherein said clasp is configured to be manipulated, said clasp frictionally engaging said rope at a selected point along said rope, said clasp being positioned outside of said tube such that said clasp retains said tube at a selected diameter when said rope is tightened, said clasp frictionally disengaging said rope when said clasp is manipulated.
